(19) United States
(12) Patent Application Publication
(10) Pub. No.: US 2011/0025188 A1
(43) Pub. Date: Feb. 3, 2011

(54) Field emission lamp and method for making the same

(75) Inventors: Tzung-Han Yang, Taipei (TW); Bing-Da Dai, Taipei (TW)

Correspondence Address: BACON & THOMAS, PLLC, 625 SLATERS LANE, FOURTH FLOOR, ALEXANDRIA, VA, 22314-1176, US

(73) Assignee: Tatung Company, Taipei (TW)

(21) Appl. No.: 12/591,181

(22) Filed: Nov. 12, 2009

(30) Foreign Application Priority Data
Aug. 3, 2009 (TW) 098126052

(51) Int. Cl. H01J 19/32; H01J 9/00

(52) U.S. Cl. 313/497; 445/58; 977/742; 977/949

(57) ABSTRACT

A field emission lamp and method of fabricating the same are disclosed, the field emission lamp of the present invention comprising a lamp tube, an anode, at least one auxiliary electrode, a cathode, and an emitter layer. The anode comprises a transparent conductive layer and a phosphor layer, and the transparent conductive layer is made of ITO, IZO, AZO, GZO, zinc oxide, or the combination thereof. The auxiliary electrode of the field emission lamp of the present invention can shorten the electron transportation path length, increase the electron transportation efficiency, reduce the phenomenon of micro-discharges caused by electron charging, reduce the voltage loss, reduce the temperature increase of the phosphor layer and elongate the lifetime of the field emission lamp.

### BACKGROUND OF THE INVENTION

1. Field of the Invention

The present invention relates to a field emission lamp and a method for making the same.

2. Description of Related Art

Fluorescent lamps widely used for illumination usually contain a transparent glass tube coated with fluorescent materials on their inner walls, and a mercury vapor filled in the transparent glass tube. Though fluorescent lamps are advantageous in high brightness, the mercury vapor therein threatens the health of human beings since fractures or leakage of the tube result in the release of toxic mercury vapor.

Therefore, a novel field emission lamp without the usage of mercury vapor has been developed, as illustrated in FIG. 1, which comprises: a transparent glass tube 10, an anode 11, a cathode 13, and a field emission layer 14, in which the anode 11 comprises a transparent conductive layer 111 and a phosphor layer 112.

In a conventional field emission lamp, the transparent conductive layer 111 is usually made of carbon nanotubes (CNT). When attempts are made to increase the electrical conductivity of the CNT transparent conductive layer, it is usually achieved by increasing the concentration of the CNT solution (i.e. the paste) of the conductive layer in the process of depositing the CNT solution on the inner wall of the lamp tube. However, the light transmittance of the CNT transparent conductive layer may decrease with the increasing of the concentration of the CNT solution. Besides, an inert gas such as nitrogen gas is required at the manufacturing of the CNT transparent conductive layer to prevent the CNT transparent conductive layer becoming decomposed during the sintering process of the phosphor layer, and therefore a high manufacturing cost will be incurred.

Also, electrons may accumulate in the insulating phosphor grains contained in the conventional phosphor layer of a field emission lamp due to the bumping of the electrons to the surface of the phosphor layer, the temperature of the phosphor layer will then increase, and sometimes the phenomenon of some micro electrical discharging will occur. Such cases may result in short lifetime and low luminous efficacy of the field emission lamp.

Therefore, it is desirable to provide an improved field emission lamp to mitigate the aforementioned problems.

### SUMMARY OF THE INVENTION

The present invention provides a field emission lamp comprising: a lamp-tube; an anode forming on the inner wall of the lamp-tube, the anode comprises a transparent conductive layer and a phosphor layer, and the transparent conductive layer locates between the inner wall of the lamp-tube and the phosphor layer; at least one auxiliary electrode; a cathode locating in the lamp-tube; and an emitter layer locating at the surface of the cathode. Preferably, the auxiliary electrode may locate between the transparent conductive layer and the phosphor layer, or locate between the transparent conductive layer and the inner wall of the lamp-tube. The transparent conductive layer is made of ITO (indium tin oxide), IZO (indium zinc oxide), AZO (aluminum doped zinc oxide), GZO (gallium doped zinc oxide), zinc oxide, or the combination thereof, and preferably the transparent conductive layer is made of ITO (indium tin oxide) to enhance a better light transmittance. The cathode can be made of any material that is used in a conventional field emission lamp such as metal, metal covered with CNT (carbon nanotube), or alloy (such as Ni/Au alloy) covered with carbon film. The auxiliary electrode of the present invention is helpful for shortening the electron transportation path length, and therefore the transportation efficiency of the electrons can be enhanced. Since the auxiliary electrode of the present invention can properly transfer the electrons accumulated in the phosphor layer, with the usage of the auxiliary electrode of the present invention, the phenomenon of micro electrical discharges caused by electron accumulation can be reduced, the voltage loss can be reduced, the temperature increase of the phosphor layer can be reduced, and therefore the lifetime of the field emission lamp can be elongated.

According to the field emission lamp of the present invention, the auxiliary electrode is preferably made in a linear form, a net form, a helix form, a ring form, or in a form comprising at least two selected from the group consisting of: a linear form, a helix form, and a ring form. The auxiliary electrode can be made in various forms to be randomly distributed in the lamp tube, and therefore can uniformly and efficiently evacuate the electron accumulation.

According to the field emission lamp of the present invention, the auxiliary electrode may be preferably made of silver, copper, nickel, aluminum, graphite, or the combinations thereof, more preferably made of silver.

According to the field emission lamp of the present invention, the line width of the auxiliary electrode is preferably 10 μm to 3000 μm, and more preferably 100 μm to 1000 μm. The line width of the auxiliary electrode is counted and determined depending on the electrical resistance of the transparent conductive layer. The auxiliary electrode may have a preferred electrical conducting efficiency when the electrical resistance of the auxiliary electrode is one-tenth or less of the electrical resistance of the transparent conductive layer. For example, the electrical resistance of the auxiliary electrode is preferably 200 ohm when the electrical resistance of the transparent conductive layer is 2K ohm, whereas the electrical resistance of the auxiliary electrode is 200 ohm when the line width of the auxiliary electrode is 20 μm, and therefore the line width of the auxiliary electrode may be determined to be 20 μm herein to obtain a better light transmittance and electrical conductivity.

According to the field emission lamp of the present invention, the cathode can be preferably made of any material that is used in a conventional field emission lamp such as metal, metal covered with CNT (carbon nanotube), or alloy (such as Ni/Au alloy) covered with carbon film. The emitter layer is preferably made of materials having good electron affinity or having electron-emitting ability such as CNT (carbon nanotube), diamond-like carbon, nano-diamond, or the combination thereof, but is not limited thereto.

The present invention also provides a method of fabricating a field emission lamp, which comprises the following steps: (S1) forming a transparent conductive layer and an auxiliary electrode on an inner wall of a lamp-tube; (S2) forming a phosphor layer covering the transparent conductive layer and the auxiliary electrode; and (S3) heating the lamp-tube with the transparent conductive layer, the auxiliary electrode, and the phosphor layer; wherein the transparent conductive layer of step (S1) is made of ITO (indium tin oxide), IZO (indium zinc oxide), AZO (aluminum doped zinc oxide), GZO (gallium doped zinc oxide), zinc oxide, or the combination thereof.

According to the method of fabricating a field emission lamp of the present invention, preferably the step (S1) may be: forming the transparent conductive layer on the inner wall of the lamp-tube, and then forming the auxiliary electrode on the transparent conductive layer; or forming the auxiliary electrode on the inner wall of the lamp-tube, and then forming the transparent conductive layer covering the auxiliary electrode, wherein the auxiliary electrode locates between the inner wall of the lamp-tube and the transparent conductive layer.

According to the method of fabricating a field emission lamp of the present invention, in the step (S1), by using a tube with a hole, the auxiliary electrode can be preferably made by spraying the ink to the surface of the transparent conductive layer from a hole of the tube filled with ink. The ink is preferably a silver ink. Preferably, in the step (S1), the auxiliary electrode can be made by rotating the tube filled with ink while spraying the ink to the surface of the transparent conductive layer from the hole of the tube to form a helix-shaped auxiliary electrode or a ring-shaped auxiliary electrode.

According to the method of fabricating a field emission lamp of the present invention, in the step (S1), the auxiliary electrode may be preferably made by pouring the ink on the transparent conductive layer along the inner wall of the lamp-tube.

Further, according to the method of fabricating a field emission lamp of the present invention, in the step (S1), the auxiliary electrode may be preferably made by soaking a filament in ink and attaching the soaked filament to the surface of the transparent conductive layer to let the ink to be formed on the transparent conductive layer.

According to the method of fabricating a field emission lamp of the present invention, in the step (S1), the transparent conductive layer is preferably made of ITO (indium tin oxide). Generally, ITO film has a higher electrical conductivity than CNT (carbon nanotube) film. Based upon the same light transmittance, an ITO film has a higher electrical conductivity than a CNT film. In detail, when someone wants to increase the electrical conductivity of the CNT transparent conductive layer, it will be obtained by increasing the concentration of the CNT solution (i.e. the paste) of the conductive layer in the process of depositing the CNT solution on the inner wall of the lamp tube. However, when the concentration of the CNT solution is increased, the light transmittance of the CNT transparent conductive layer may decrease. Besides, in a conventional method of fabricating a field emission lamp, an inert gas such as nitrogen gas is required in the manufacturing of the CNT transparent conductive layer, in order to prevent the CNT transparent conductive layer from becoming decomposed during the sintering process of the phosphor layer. In contrast, in the method of fabricating a field emission lamp of the present invention, inert gas is not needed because the ITO transparent conductive layer can be heated with the phosphor layer and remains undamaged in the air. Therefore, the cost for manufacturing the field emission lamp can be reduced. Besides, when the ITO transparent conductive layer is heated with the phosphor layer, the phosphor paste provides oxygen vacancy, the resistance of the ITO transparent conductive layer is lowered, and therefore the electric conductivity of the ITO transparent conductive layer is increased.

According to the method of fabricating a field emission lamp of the present invention, the ITO transparent conductive layer is preferably made by the following steps: (A) filling the lamp-tube with an ITO solution; (B) draining the ITO solution from the lamp-tube and leaving an ITO thin film on the inner surface of the lamp-tube; and (C) heating the lamp-tube with the ITO thin film formed on the inner surface thereof. In a conventional method, an ITO transparent conductive layer is made by a physical vapor deposition method which applies high voltage to the target (sputtering material) under a vacuum circumstance, impacting the target (sputtering material) with the ionized inert gas to generate small particles, following with depositing those generated particles on the substrate. However, the cost involved is high and the thickness uniformity of the ITO transparent conductive layer cannot be satisfactory when a lamp tube is applied for functioning as the substrate. In contrast, the ITO transparent conductive layer of the present invention is fabricated by forming an ITO solution thin film on the inner surface of the lamp-tube following with a heating process, wherein the equipment used is inexpensive and therefore the cost involved can be lowered. The ITO transparent conductive layer formed by the method of the present invention has excellent thickness uniformity and high strength that enables the formed ITO transparent conductive layer not to be fragile.

According to the method of fabricating a field emission lamp of the present invention, the auxiliary electrode is preferably made in a linear form, a net form, a helix form, a ring form, or in a form comprising at least two selected from the group consisting of: a linear form, a helix form, and a ring form. The auxiliary electrode can be made in various forms to be randomly distributed in the lamp tube, and therefore can uniformly and efficiently evacuate the electron accumulation.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of a conventional field emission lamp;

FIG. 2 is a schematic view of a field emission lamp of the example 1;

FIG. 3 is a schematic view of a field emission lamp of the example 2;

FIG. 4 is a schematic view of a field emission lamp of the example 3;

FIG. 5 is a schematic view of a field emission lamp of the example 4;

FIG. 6 is a process flow chart for fabricating a field emission lamp of the example 5;

FIG. 7 is a process flow chart for fabricating a field emission lamp of the example 6;

FIG. 8 is a schematic view showing the process of fabricating the auxiliary electrode of the example 5;

FIG. 9 is a schematic view showing the process of fabricating the auxiliary electrode of the example 7;

FIG. 10 is a schematic view showing the process of fabricating the auxiliary electrode of the example 8; and

FIG. 11 is a schematic view showing the process of fabricating the auxiliary electrode of the example 9.

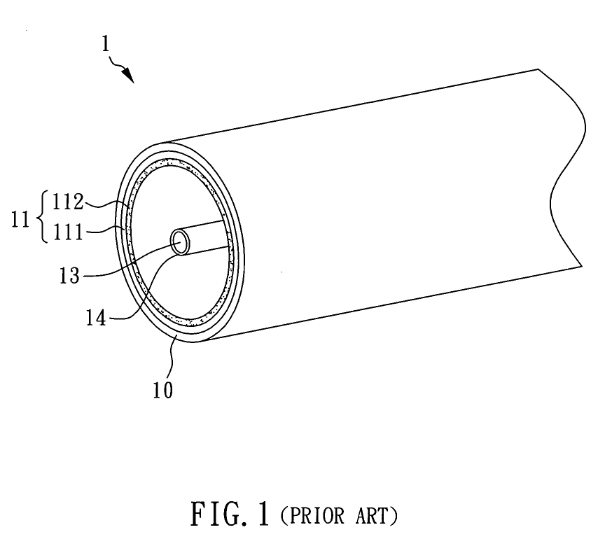

### DETAILED DESCRIPTION OF THE PREFERRED EMBODIMENT

Hereinafter, the present invention will be described in further detail with reference to examples and comparative examples. It is to be understood, however, that these examples are illustrative only and the scope of the present invention is not limited thereto.

### Example 1

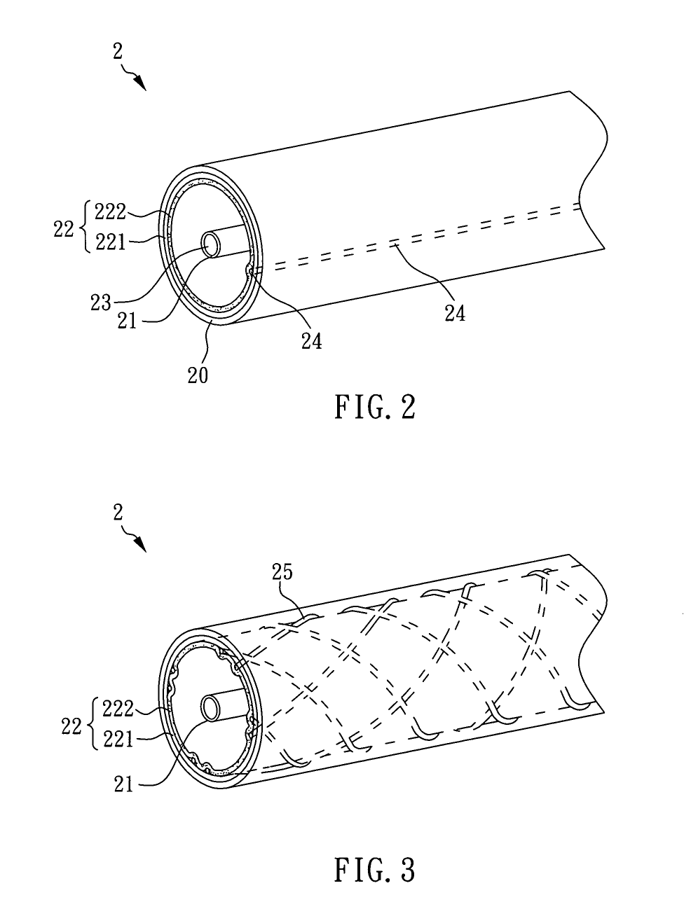

With reference to FIG. 2, there is shown a field emission lamp of the present example 1, which comprises a lamp-tube 20, an anode 22, an auxiliary electrode 24, a cathode 23, and an emitter layer 21. The anode 22 forms on the inner wall of the lamp-tube 20 and comprises a transparent conductive layer 221 and a phosphor layer 222. The transparent conductive layer 221 is made of ITO (indium tin oxide) to enhance high light-transmittance. The auxiliary electrode 24 is in a linear form and locates between the transparent conductive layer 221 and the phosphor layer 222. The auxiliary electrode 24 is made of silver and the line width of the auxiliary electrode is 500 μm. The cathode 23 locates in center of the lamp-tube 20 and is a nickel-chromium alloy wire. The emitter layer 21 locates on the surface of the cathode 23 and is made of CNT (carbon nanotube).

The auxiliary electrode 24 is helpful for shortening the electron transportation path length, and therefore the transportation efficiency of the electrons can be enhanced. Since the auxiliary electrode 24 of the present invention can properly transfer the electrons accumulated in the phosphor layer, with the usage of the auxiliary electrode 24 of the present invention, the phenomenon of micro electric discharges caused by electron accumulation can be reduced, the voltage loss can be reduced, the temperature increase of the phosphor layer can be reduced, and therefore the lifetime of the field emission lamp can be elongated. Besides, the transparent conductive layer 221 of the anode 22 of the present invention, which is made of ITO, has a higher electrical conductivity than one made of CNT (carbon nanotube) of a conventional field emission lamp based upon the same light transmittance, because the electrical conductivity of the ITO thin film is greater than the electrical conductivity of a CNT thin film.

### Example 2

With reference to FIG. 3, there is shown a field emission lamp of the present example 2. Except that the auxiliary electrode 25 is in a net form, the material of the emitter layer 21 is diamond-like carbon instead of CNT, and the material of the auxiliary electrode 25 is copper, the field emission lamp of the present example 2 is the same as that described in the example 1.

### Example 3

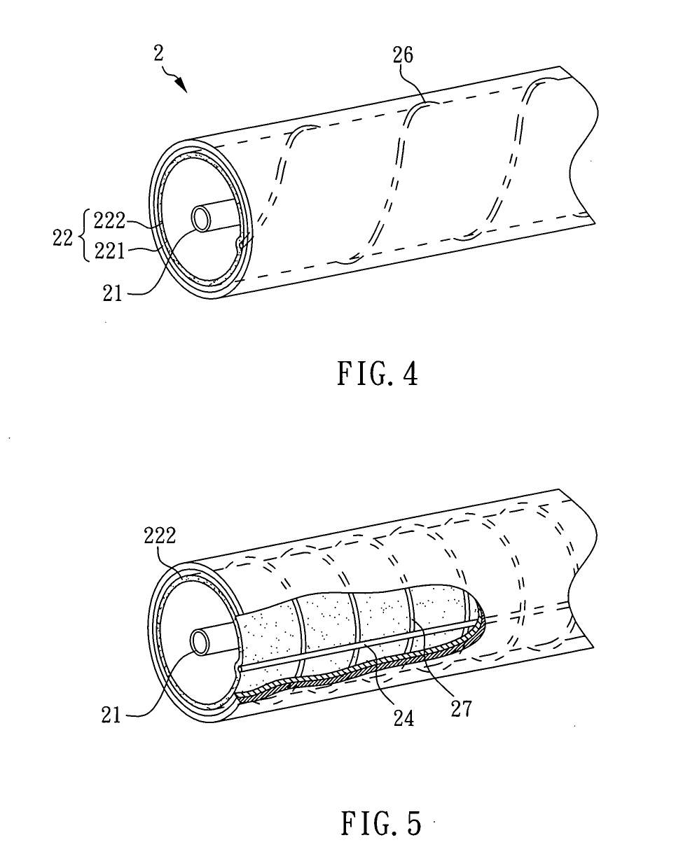

With reference to FIG. 4, there is shown a field emission lamp of the present example 3. Except that the auxiliary electrode 26 is in a helix form, the material of the emitter layer 21 is nano-diamond instead of CNT, and the material of the auxiliary electrode 26 is nickel, the field emission lamp of the present example 3 is the same as that of the example 1.

### Example 4

With reference to FIG. 5, there is shown a field emission lamp of the present example 4. Except that the auxiliary electrode of the present example 4 is composed of a linear form auxiliary electrode 27 and a ring form auxiliary electrodes 24, and the material of the auxiliary electrode 24 with ring form is graphite, the field emission lamp of the present example 3 is the same as that of the example 1.

### Example 5

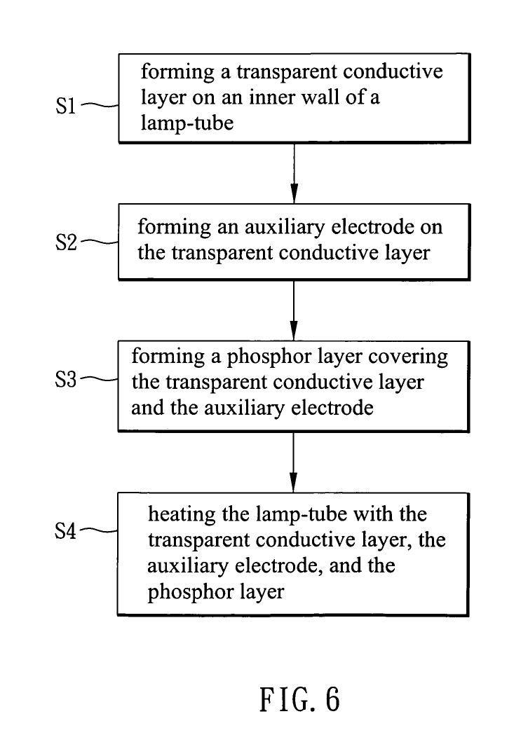

With reference to FIG. 6, there is shown a process flow chart for fabricating a field emission lamp of the present invention, which comprises: (S1) forming a transparent conductive layer on an inner wall of a lamp-tube; (S2) forming an auxiliary electrode on the transparent conductive layer; (S3) forming a phosphor layer covering the transparent conductive layer and the auxiliary electrode; and (S4) heating the lamp-tube with the transparent conductive layer, the auxiliary electrode, and the phosphor layer. In the present example, the material of the transparent conductive layer is ITO (indium tin oxide). Generally, ITO film has a higher electrical conductivity than CNT (carbon nanotube)film. Based upon the same light transmittance, an ITO layer has a higher electrical conductivity than a CNT layer. In detail, when someone wants to increase the electrical conductivity of the CNT transparent conductive layer, it will be obtained by increasing the concentration of the CNT solution (i.e. the paste) of the conductive layer in the process of coating the inner wall of the lamp tube with the CNT solution. However, when the concentration of the CNT solution is increased, the light transmittance of the CNT transparent conductive layer may decrease. Besides, in a conventional method of fabricating a field emission lamp, an inert gas such as nitrogen gas is required at the manufacturing of the CNT transparent conductive layer, in order to prevent the CNT transparent conductive layer from becoming decomposed during the sintering process of the phosphor layer. In contrast, in the method of fabricating a field emission lamp of the present invention, inert gas is not needed because the ITO transparent conductive layer can be heated with the phosphor layer and remains undamaged in the air. Therefore, the cost for manufacturing the field emission lamp can be reduced. Besides, when the ITO transparent conductive layer is heated with the phosphor layer, the phosphor paste provides oxygen vacancy, resistance of the ITO transparent conductive layer is lowered, and therefore the electric conductivity of the ITO transparent conductive layer is increased.

In the present example, the ITO transparent conductive layer is made by the following steps: (A) filling the lamp-tube with an ITO solution; (B) draining the ITO solution from the lamp-tube and leaving an ITO solution thin film on the inner surface of the lamp-tube; and (C) heating the lamp-tube with the ITO solution thin film formed on the inner surface thereof. In a conventional method, an ITO transparent conductive layer is made by a physical vapor deposition method which applies high voltage to the target (sputtering material) under a vacuum circumstance, impacting the target (sputtering material) with the ionized inert gas to generate small particles, following with depositing those generated particles on the substrate. However, the cost involved is high and the thickness uniformity of the ITO transparent conductive layer cannot be satisfactory when a lamp tube is applied for functioning as the substrate. In the contrast, the ITO transparent conductive layer of the present invention is fabricated by forming an ITO solution thin film on the inner surface of the lamp-tube following with a heating process, the equipment used is inexpensive and therefore the cost involved can be lowered. The ITO transparent conductive layer formed by the method of the present invention has excellent thickness uniformity and significant strength that enables the formed ITO transparent conductive layer not to be fragile.

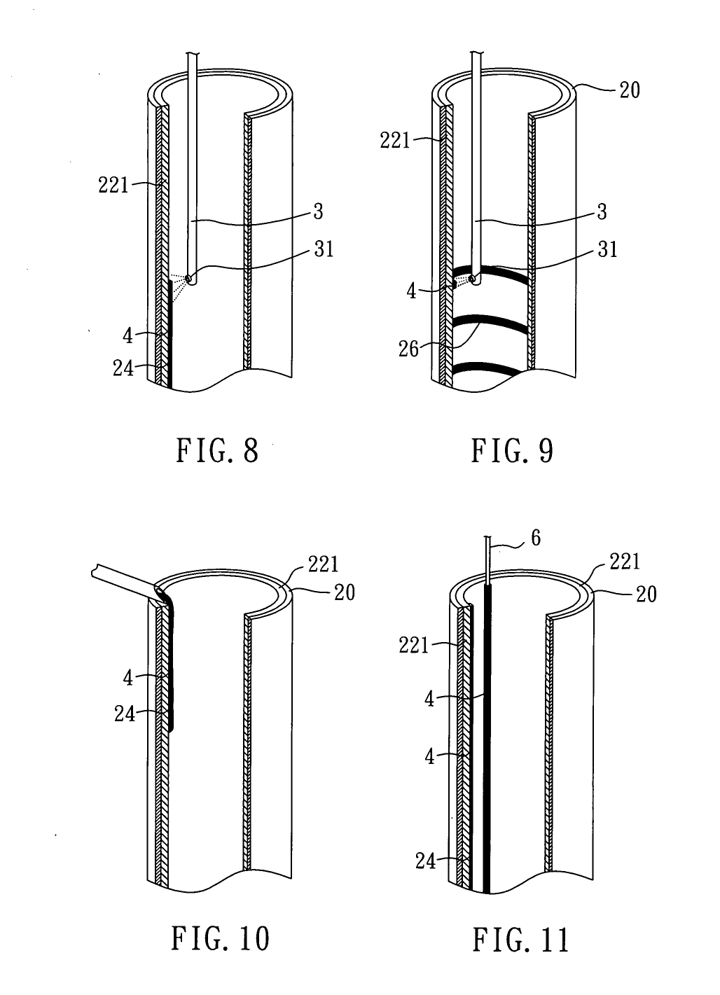

With reference to FIG. 8, the auxiliary electrode of the present example is formed by filling a tube 3 with ink 4 and spraying the ink 4 from a hole 31 of the tube 3 to the surface of the transparent conductive layer 221, in which the ink 4 is a silver paste.

### Example 6

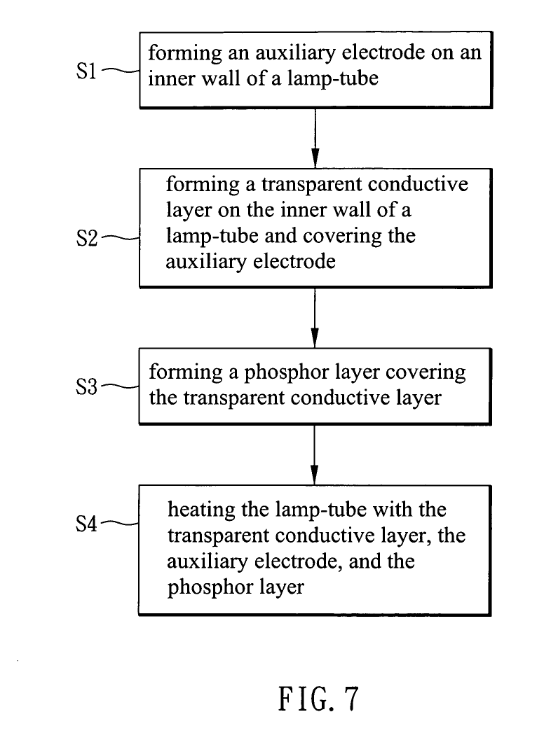

With reference to FIG. 7, a process flow chart of fabricating a field emission lamp of the present invention is shown, which comprises: (S1) forming an auxiliary electrode on an inner wall of a lamp-tube; (S2) forming a transparent conductive layer on the inner wall of a lamp-tube and covering the auxiliary electrode; (S3) forming a phosphor layer covering the transparent conductive layer; and (S4) heating the lamp-tube with the transparent conductive layer, the auxiliary electrode, and the phosphor layer.

According to the method of the present example, the auxiliary electrode is first formed on the inner wall of a lamp-tube followed by the forming of the transparent conductive layer, which means the formed auxiliary electrode is located between the inner wall of a lamp-tube and the transparent conductive layer. Except the steps described herein are used instead of those described in the example 5, the other conditions and steps are the same for forming the field emission lamp in the present example.

### Example 7

With reference to FIG. 9, a schematic view of forming an auxiliary electrode in a helix form is shown. In the present example, the auxiliary electrode is formed by filling a tube 3 with ink 4, and then rotating the tube 3 simultaneously with spraying the ink 4 from the hole 31 of the tube 3 to the surface of the transparent conductive layer 221. Except the steps of forming the auxiliary electrode described herein are used instead of those described in the example 5, the other conditions and steps are the same for forming the field emission lamp in the present example.

### Example 8

With reference to FIG. 10, a schematic view of forming an auxiliary electrode is shown. In the present example, the auxiliary electrode 26 is formed by pouring the ink 4 on the surface of the transparent conductive layer 221 along the inner wall of the lamp-tube 20. The ink 4 poured thus forms a linear shape on the surface of the transparent conductive layer 221. Except the steps of forming the auxiliary electrode described herein are used instead of those described in the example 5, the other conditions and steps are the same for forming the field emission lamp in the present example.

### Example 9

With reference to FIG. 11, a schematic view of forming an auxiliary electrode is shown. In the present example, the auxiliary electrode 24 is formed by soaking a filament 6 in ink 4 and attaching the soaked filament 6 to the surface of the transparent conductive layer 221 locating on the inner wall of the lamp-tube 20. Except the steps of forming the auxiliary electrode described herein are used instead of those described in the example 5, the other conditions and steps are the same for forming the field emission lamp in the present example.

Alternatively, by the combinations of the steps of forming the auxiliary electrode described above, it is easy to achieve an auxiliary electrode in any required forms such as a form comprising at least two selected from the group consisting of: a linear form, a helix form, and a ring form.

Although the present invention has been explained in relation to its preferred embodiment, it is to be understood that many other possible modifications and variations can be made without departing from the scope of the invention as hereinafter claimed.

What is claimed is:

1. A field emission lamp comprising:
a lamp-tube;
an anode forming on the inner wall of the lamp-tube, the anode comprises a transparent conductive layer and a phosphor layer;
at least one auxiliary electrode;
a cathode locating in the lamp-tube; and
an emitter layer locating at the surface of the cathode;
wherein the transparent conductive layer is made of ITO (indium tin oxide), IZO (indium zinc oxide), AZO (aluminum doped zinc oxide), GZO (gallium doped zinc oxide), zinc oxide, or a combination thereof.

2. The field emission lamp as claimed in claim 1, wherein the at least one auxiliary electrode locates between the transparent conductive layer and the phosphor layer.

3. The field emission lamp as claimed in claim 1, wherein the at least one auxiliary electrode locates between the transparent conductive layer and the inner wall of the lamp-tube.

4. The field emission lamp as claimed in claim 1, wherein the at least one auxiliary electrode is in a linear form.

5. The field emission lamp as claimed in claim 1, wherein the at least one auxiliary electrode is in a net form.

6. The field emission lamp as claimed in claim 1, wherein the at least one auxiliary electrode is in a helix form.

7. The field emission lamp as claimed in claim 1, wherein the at least one auxiliary electrode is in a ring form.

8. The field emission lamp as claimed in claim 1, wherein the at least one auxiliary electrode is in a form comprising at least two selected from a group consisting of: a linear form, a helix form, and a ring form.

9. The field emission lamp as claimed in claim 1, wherein the at least one auxiliary electrode is made of silver, copper, nickel, aluminum, graphite, or combinations thereof.

10. The field emission lamp as claimed in claim 1, wherein the at least one auxiliary electrode has a line width of 10 μm to 3000 μm.

11. The field emission lamp as claimed in claim 1, wherein the transparent conductive layer is made of ITO (indium tin oxide).

12. The field emission lamp as claimed in claim 1, wherein the cathode is made of metal.

13. The field emission lamp as claimed in claim 1, wherein the emitter layer is made of CNT (carbon nanotube), diamond-like carbon, nano-diamond, or a combination thereof.

14. A method of fabricating a field emission lamp, which comprises following steps:
(S1) forming a transparent conductive layer and an auxiliary electrode on an inner wall of a lamp-tube;
(S2) forming a phosphor layer covering the transparent conductive layer and the auxiliary electrode; and
(S3) heating the lamp-tube with the transparent conductive layer, the auxiliary electrode, and the phosphor layer;
wherein the transparent conductive layer of step (S1) is made of ITO (indium tin oxide), IZO (indium zinc oxide), AZO (aluminum doped zinc oxide), GZO (gallium doped zinc oxide), zinc oxide, or a combination thereof.

15. The method of fabricating a field emission lamp as claimed in claim 14, wherein the step (S1) is: forming the transparent conductive layer on the inner wall of the lamp-tube, and then forming the auxiliary electrode on the transparent conductive layer.

16. The method of fabricating a field emission lamp as claimed in claim 14, wherein the step (S1) is: forming the auxiliary electrode on the inner wall of the lamp-tube, and then forming the transparent conductive layer covering the auxiliary electrode, wherein the auxiliary electrode locates between the inner wall of the lamp-tube and the transparent conductive layer.

17. The method of fabricating a field emission lamp as claimed in claim 14, wherein in the step (S1), the auxiliary electrode is made by spraying an ink to the surface of the transparent conductive layer from a hole of a tube filled with the ink.

18. The method of fabricating a field emission lamp as claimed in claim 17, wherein the ink is a silver ink.

19. The method of fabricating a field emission lamp as claimed in claim 14, wherein in the step (S1), the auxiliary electrode is made by pouring an ink on the transparent conductive layer along the inner wall of the lamp-tube.

20. The method of fabricating a field emission lamp as claimed in claim 14, wherein in the step (S1), the auxiliary electrode is made by soaking a filament in an ink and attaching the soaked filament to the surface of the transparent conductive layer to let the ink to be formed on the transparent conductive layer.

21. The method of fabricating a field emission lamp as claimed in claim 17, wherein in the step (S1), the tube rotates simultaneously while the tube sprays the ink to form a helix-shaped auxiliary electrode or a ring-shaped auxiliary electrode.

22. The method of fabricating a field emission lamp as claimed in claim 14, wherein the transparent conductive layer of the step (S1) is made of ITO (indium tin oxide).

23. The method of fabricating a field emission lamp as claimed in claim 22, wherein the ITO transparent conductive layer is made by following steps: (A) filling the lamp-tube with an ITO solution; (B) draining the ITO solution from the lamp-tube and leaving an ITO solution thin film on the inner surface of the lamp-tube; and (C) heating the lamp-tube with the ITO solution thin film formed on the inner surface thereof.

24. The method of fabricating a field emission lamp as claimed in claim 14, wherein the auxiliary electrode is in a linear form.

25. The method of fabricating a field emission lamp as claimed in claim 14, wherein the auxiliary electrode is in a net form.

26. The method of fabricating a field emission lamp as claimed in claim 14, wherein the auxiliary electrode is in a form comprising at least two selected from a group consisting of: a linear form, a helix form, and a ring form.
